(19) United States
(12) Patent Application Publication
(10) Pub. No.: US 2021/0289921 A1
(43) Pub. Date: Sep. 23, 2021

(54) SELF-HEATING DEVICE

(71) Applicant: Libo Cosmetics Co., Ltd., Taichung (TW)

(72) Inventor: Hsiao-Yun Lin, Taichung (TW)

(21) Appl. No.: 16/820,741

(22) Filed: Mar. 17, 2020

(51) Int. Cl. A45D 40/18; A45D 44/00

(52) U.S. Cl. CPC A45D 40/18; A45D 2200/155; A45D 44/005

(57) ABSTRACT

A self-heating device includes a palette and a stove. The palette includes a stepped portion extending around a planar portion. The stove includes an upper shell connected to a lower shell. The upper shell includes a stepped rim for supporting the stepped portion of the palette. A heater is supported on the stepped rim, below the planar portion of the palette. A heating circuit board is connected to the heater and located in the stepped rim. A button is supported on the upper shell and operable to turn on or off the heating circuit board. A battery is connected to the heating circuit board. A recharging circuit board is connected to the battery. A recharging port is connected to the recharging circuit board, thereby allowing connection of the recharging circuit board to an external power supply via the recharging port.

### BACKGROUND OF INVENTION

### 1. Field of Invention

The present invention relates to cosmetics and, more particularly, to a self-heating device for cosmetics.

### 2. Related Prior Art

Like clothes in a wardrobe, cosmetics are always short of a color. As seasons or fashion change, consumers tend to feel lack of some cosmetics. A user often uses cosmetics such as foundation, concealer, blush, lipstick and lip gloss on the back of a hand. Thus, the user is allowed to observe the color of the cosmetics in contrast of the color of the user's skin to determine whether she or he likes the color of the cosmetics. The user can mix the color with the cosmetics with the colors of some other cosmetics to obtain a color that she or he likes. Then, the user can wipe the cosmetics from the back of the hand with paper towel or facial paper.

Referring to FIG. 5, a conventional palette 90 includes several raw-material regions 92, a mixture region 94 and an aperture 96. The raw-material regions 92 and the aperture 96 are located around the mixture region 94.

A user (not shown) put an amount of a cosmetic material 12 onto one of the raw-material regions 92 and another amount of another cosmetic material 14 onto another one of the raw-material regions 92. Some of the cosmetic material 12 and some of the cosmetic material 14 are moved onto the mixture region 94 from the related raw-material regions 92. The cosmetic materials 12 and 14 are mixed with each other to provide a mixed material 16. The user can insert a thumb in the aperture 96 to hold the palette 90 steadily.

However, in a cold environment, it is not easy to spread the cosmetic materials 12 and 14 in the form of paste or gel. Thus, it takes a long period of time to mix the cosmetic materials 12 and 14 with each other. Hence, the user has to spend quite some time before he or she can use the mixed material 16.

The present invention is therefore intended to obviate or at least alleviate the problems encountered in prior art.

### SUMMARY OF INVENTION

It is the primary objective of the present invention to provide a self-heating palette device.

To achieve the foregoing objective, the self-heating device includes a palette and a stove. The palette includes a stepped portion extending around a planar portion. The stove includes an upper shell and a lower shell. The upper shell includes a stepped rim for supporting the stepped portion of the palette. The lower shell is connected to the upper shell. A heater is supported on the stepped rim of the upper shell and located below the planar portion of the palette. A heating circuit board is connected to the heater and located in the stepped rim of the upper shell. A button is supported on the upper shell and operable to turn on or off the heating circuit board. A battery is connected to the heating circuit board. A recharging circuit board is connected to the battery. A recharging port is connected to the recharging circuit board, thereby allowing connection of the recharging circuit board to an external power supply via the recharging port.

Other objectives, advantages and features of the present invention will be apparent from the following description referring to the attached drawings.

### BRIEF DESCRIPTION OF DRAWINGS

The present invention will be described via detailed illustration of the preferred embodiment referring to the drawings wherein:

FIG. 1 is a perspective view of a self-heating device according to the preferred embodiment of the present invention;

FIG. 2 is a cut-away view of the self-heating device shown in FIG. 1;

FIG. 3 is a cross-sectional view of a portion of the self-heating device shown in FIG. 1;

FIG. 4 is a cross-sectional view of another portion of the self-heating device shown in FIG. 1; and

FIG. 5 is a perspective view of a conventional palette.

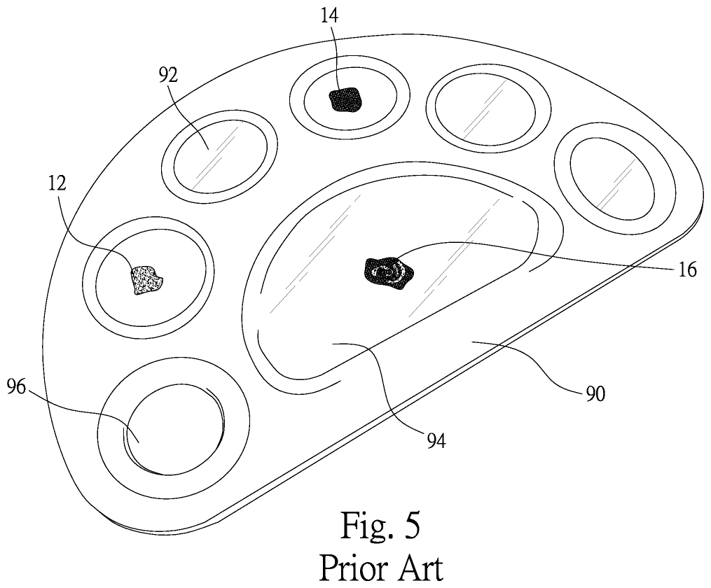

### DETAILED DESCRIPTION OF PREFERRED EMBODIMENT

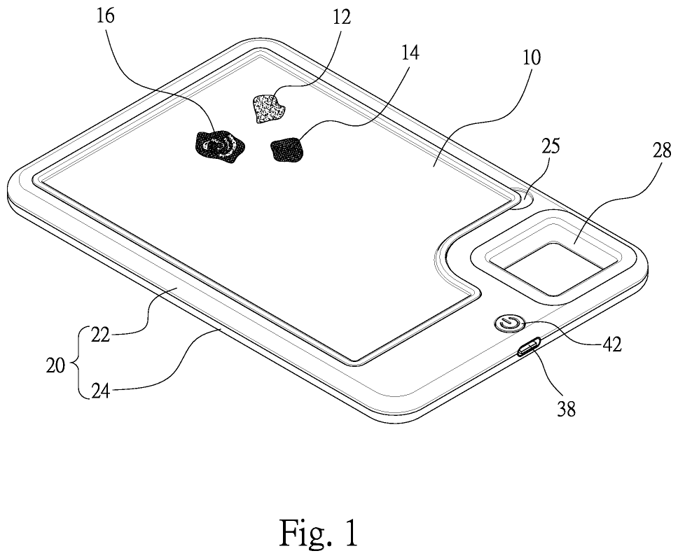

Referring to FIG. 1, a self-heating device includes a palette 10 and a stove 20 according to the preferred embodiment. The palette 10 is supported on the stove 20. To this end, the stove 20 is shaped in compliance with the palette 10.

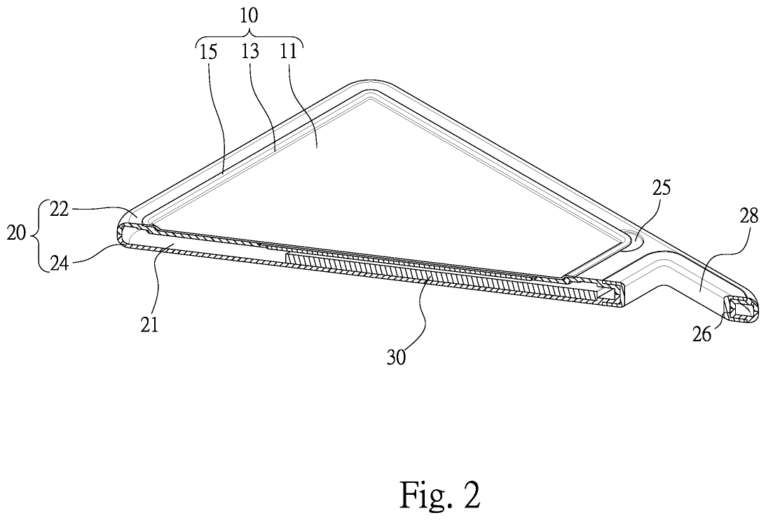

Referring to FIG. 2, the stove 20 includes an upper shell 22 and a lower shell 24. The upper shell 22 is connected to the lower shell 24 to provide a casing (not numbered) that includes a space 21. An aperture 26 is made in a corner of the casing of the stove 20. The aperture 26 is made by an aperture in the upper shell 22 and a corresponding aperture in the lower shell 24. A soft layer 28 is provided on an annular portion of the stove 20 that extends around the aperture 26. A user (not shown) can insert a thumb in the aperture 26 to hold the self-heating device steadily. The soft layer 28 provides a soft can comfortable touch to the user.

The palette 10 includes a planar portion 11, a stepped portion 13 and an edge 15. The stepped portion 13 extends around the planar portion 11 and includes an edge 15 extending outwards. A corner of the edge 15 is inserted in a recessed portion 25 of the upper shell 22. The recessed portion 25 facilitate removal of the palette 10 from the stove 20. In addition, the edge 15 of the palette 10 includes an L-shaped section in corresponding to the soft layer 28 or the aperture 26.

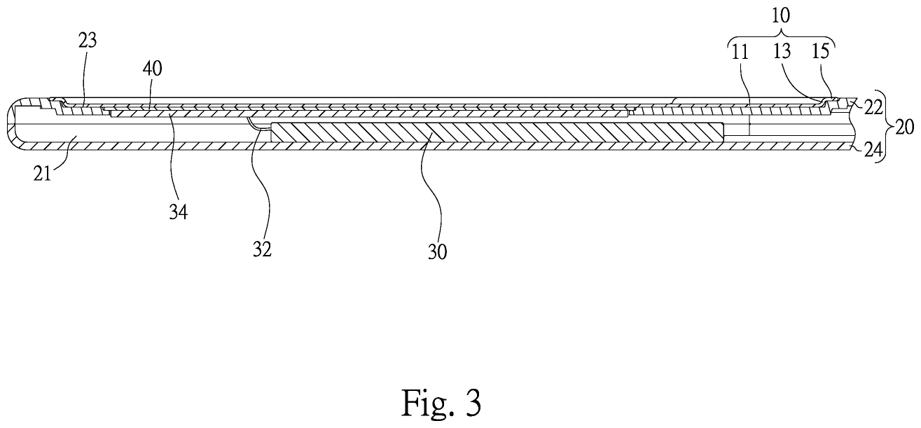

Referring to FIG. 3, the upper shell 22 includes a stepped rim 23 in the form of a frame, i.e., the stepped rim 23 extends around an opening (not numbered). The stepped rim 23 includes an upper portion, a lower portion and a middle portion. The lower portion of the stepped rim 23 supports a peripheral portion of the heater 40 in the form of a plate. The peripheral portion of the heater 40 is adhered to the lower portion of the stepped rim 23, thereby closing the opening in the stepped rim 23. The heater 40 is made of stainless steel or another sort of metal. The upper and middle portions of the stepped rim 23 support the stepped portion 13 of the palette 10.

Moreover, a heating circuit board 34 is inserted in the space 21 and, more particularly, in the opening of the stepped rim 23. That is, the stepped rim 23 extends around the heating circuit board 34. The heating circuit board 34 is connected to the heater 40 electrically and/or mechanically. The heating circuit board 34 is equipped with a battery 30 that is inserted in the space 21 of the stove 20. Preferably, the battery 30 is rechargeable battery. The rechargeable battery 30 is electrically connected to the heating circuit board 34 via an electrical conductive element such as a wire 32.

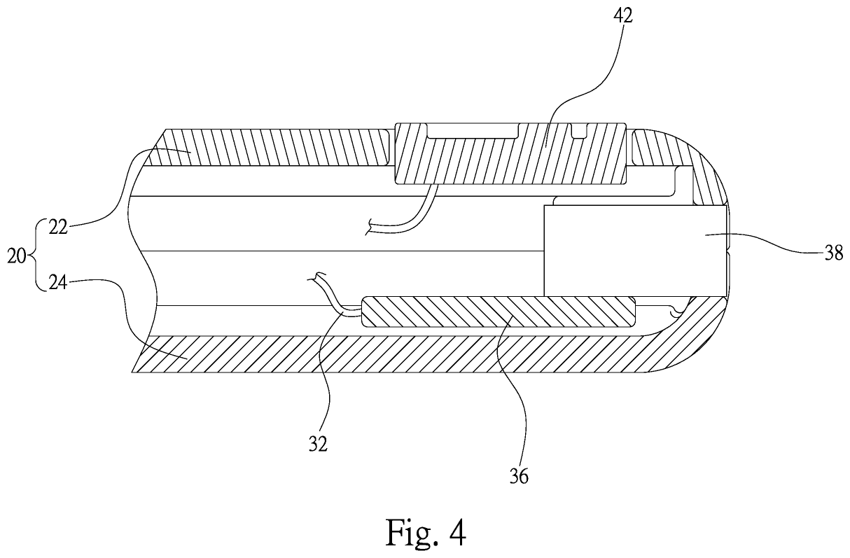

Referring to FIG. 4, via the wire 32 or an electronic circuit, the recharging circuit board 36 electrically connects the battery 30 to a recharging port 38. The recharging port 38 is located in a place where the upper shell 22 is in contact with the lower shell 24. The recharging port 38 is used to receive electricity from an external power supply such as the grid so that the rechargeable battery 30 is recharged. A button 42 is located on the upper shell 22. The button 42 is operable to turn on or off the heating circuit board.

Referring to FIGS. 1 and 3, the button 42 can be pushed to turn on the heating circuit board 34 so that the heating circuit board 34 converts electricity to heat that is transferred to the heater 40. The heater 40 heats the palette 10 that in turn heats and hence softens cosmetic materials 12 and 14 in the form of paste or gel. Thus, it is rendered easy to spread and mix the cosmetic materials 12 and 14 with each other to provide a mixed material 16. Thus, the palette 10 expedites the mixture of the cosmetic materials 12 and 14 with each other and the provision and use of the mixed material 16.

The present invention has been described via the illustration of the preferred embodiment. Those skilled in the art can derive variations from the preferred embodiment without departing from the scope of the present invention. Therefore, the preferred embodiment shall not limit the scope of the present invention defined in the claims.

1. A self-heating device comprising:
a palette comprising a planar portion and a stepped portion extending around the planar portion;
a stove comprising:
an upper shell comprising a stepped rim for supporting the stepped portion of the palette;
a lower shell connected to the upper shell;
a heater supported on the stepped rim of the upper shell and located below the planar portion of the palette;
a heating circuit board connected to the heater and located in the stepped rim of the upper shell;
a button supported on the upper shell and operable to turn on or off the heating circuit board;
a battery connected to the heating circuit board;
a recharging circuit board connected to the battery; and
a recharging port connected to the recharging circuit board, thereby allowing connection of the recharging circuit board to an external power supply via the recharging port.

2. The self-heating palette device according to claim 1, comprising a wire for connecting the battery to the recharging circuit board.
